(19) United States
(12) Patent Application Publication
(10) Pub. No.: US 2021/0028820 A1
(43) Pub. Date: Jan. 28, 2021

(54) Antenna and Base Station

(71) Applicant: AAC Technologies Pte. Ltd., Singapore City (SG)

(72) Inventors: Hongjuan Han, Shenzhen (CN); Yuehua Yue, Shenzhen (CN)

(21) Appl. No.: 16/990,942

(22) Filed: Aug. 11, 2020

Related U.S. Application Data
(63) Continuation of application No. PCT/CN2019/094075, filed on Jun. 30, 2019.

(51) Int. Cl. H04B 3/52; H04B 3/54; H01Q 13/02; H01Q 13/24

(52) U.S. Cl. CPC H04B 3/52; H01Q 13/24; H01Q 13/02; H04B 3/54

(57) ABSTRACT

The invention provides an antenna and a base station. The antenna comprises a plurality of antenna array parts arranged in a first direction. Each antenna array part comprises a plurality of antenna array units arranged in a second direction. Each antenna array unit comprises a plurality of antenna elements arranged in the first direction, and the first direction is vertical to the second direction. A first isolated component is arranged between adjacent two antenna array parts, and/or a second isolated component is arranged between adjacent two antenna array units. According to the antenna provided by the invention, the isolation degree of the antenna can be improved.

### FIELD OF THE PRESENT DISCLOSURE

The invention relates to the field of communication technologies, in particular to an antenna and a base station using such an antenna.

### DESCRIPTION OF RELATED ART

A 5G large scale array antenna element forms phase-controlled sub arrays by a power divider and the sub arrays are arranged to form the whole large scale array antenna. The scanning angle of the large scale array antenna in the horizontal direction is commonly ±60 degrees. According to an array antenna theory, the horizontal separation distance between adjacent two array elements is about 0.5 wavelength, and the isolation degree index between antennas is not ideal as the separation distance between two adjacent array elements is small, so that it is needed to improve the isolation degree between the antennas.

The isolation degree of the antenna comprises co-polarized isolation degree and iso-polarized isolation degree. The co-polarized isolation degree means the isolation degree between two antennas with same direction of polarization, which affects the waveforming effect of the large scale array antenna. The iso-polarized isolation degree means the isolation degree between two antennas with different directions of polarization, which affects polarization diversity gain of the large scale array antenna. The isolation degree index is a quite important index in current large scale array antenna.

Therefore, it is necessary to provide an antenna which improves the isolation degree.

### SUMMARY OF THE INVENTION

One of the main objects of the present invention is to provide an antenna with improved isolation degree.

In order to achieve the object, the present invention discloses an antenna, comprising: a plurality of antenna array parts arranged in a first direction, each antenna array part comprising a plurality of antenna array units arranged in a second direction which is perpendicular to the first direction; wherein each antenna array unit comprises a plurality of antenna elements arranged in the first direction; a first isolated component is arranged between adjacent two antenna array parts, and/or a second isolated component is arranged between adjacent two antenna array units.

As an improvement, each first isolated component comprises two first separators arranged spaced from each other.

As an improvement, each first separator comprises a first separation plate and a plurality of first metal patches arranged on the first separation plate in a spaced manner.

As an improvement, adjacent two second isolated components are arranged symmetrically about a center line of each antenna array unit.

As an improvement, each second isolated component comprises a second separation plate and a plurality of second metal patches arranged on the second separation plate in a spaced manner.

As an improvement, the antenna further comprises third isolated components arranged on two sides of the antenna in the first direction.

As an improvement, the antenna further comprises fourth isolated components arranged on two sides of each antenna array units in the second direction.

As an improvement, the antenna further comprises a substrate, wherein the antenna elements, the first isolated components and the second isolated components are arranged on the substrate.

As an improvement, the antenna is a dual polarized antenna.

The present invention further discloses a base station having such an antenna described above.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an illustration of an antenna in accordance with an exemplary embodiment of the present invention;

FIG. 2 is a partial and isometric view of the antenna in FIG. 1.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

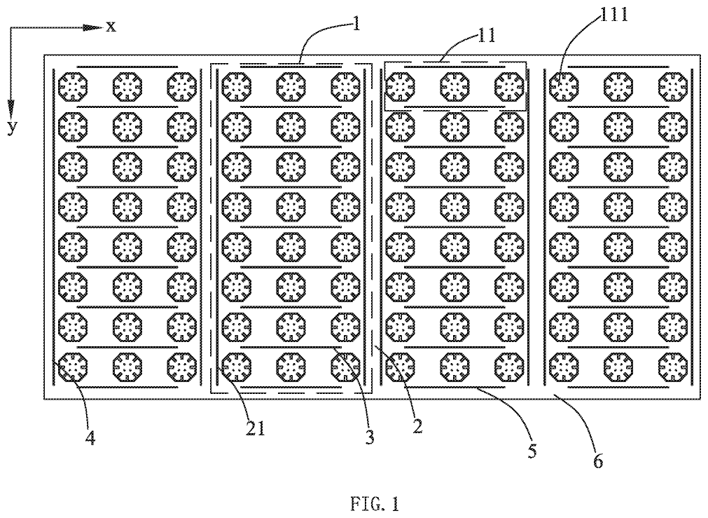

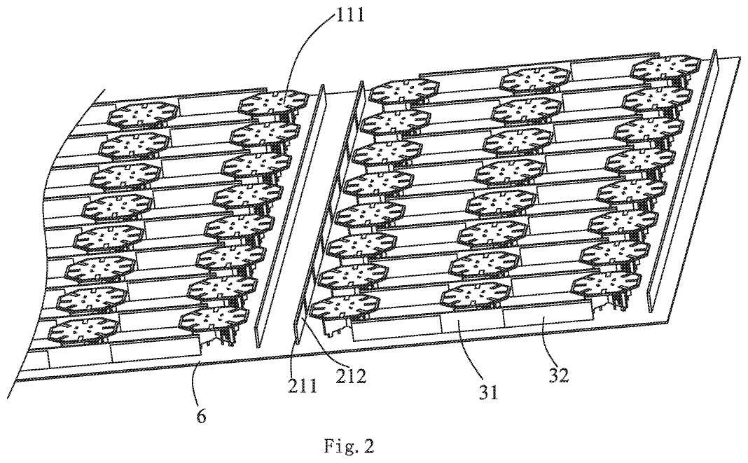

As shown in FIG. 1 to FIG. 2, x direction in the FIG. 1 is defined as a first direction, and y direction is defined as a second direction. An antenna provided by the embodiment of the invention comprises a plurality of antenna array parts 1 arranged in the first direction, each antenna array part 1 comprises a plurality of antenna array units 11 arranged in the second direction. Each antenna array unit 11 comprises a plurality of antenna elements 111 arranged in the first direction, and the first direction is vertical to the second direction; a first isolated component 2 is arranged between adjacent two antenna array parts 1, and/or a second isolated component 3 is arranged between adjacent two antenna array units 11. That is, the antenna may comprise the first isolated components 2 and the second isolated components 3 or merely comprises the first isolated components 2 or the second isolated components 3.

The first isolated components 2 and the second isolated components 3 which are adjacent are arranged in a spaced manner, and the first isolated components 2 and the second isolated components are arranged isolated from the antenna elements 111. The first isolated components 2 improve the isolation degree between adjacent two vertical polarized antennas in the antenna array unit 11 and the second isolated components 3 improve the isolation degree between adjacent two antenna array units 11, so that the isolation degree of the antenna is improved.

In an embodiment, each antenna element 111 is a dual polarized antenna, in particular a ±45 degree polarized antenna. Each antenna array unit 11 comprises two or more than two antenna elements 111, and the separation distances between adjacent two antenna elements 111 in each antenna element 111 are equal.

Each first isolated component 2 comprises first separators 21 arranged in a spaced manner. Each first separator 21 comprises a first separation plate 211 and a plurality of first metal patches 212 arranged on the first separation plate 211 in a spaced manner. The first metal patches 212 and the antenna array units 11 are oppositely arranged in a one-to-one correspondence manner, the first metal patches 212 are arranged in an equally spaced manner on the first separation plate 211, and the distance between every two first metal patches 212 is equal to the distance between every two antenna array units 11. The first metal patches 212 are arranged in a spaced manner on two sides of each first separation plate 211.

Adjacent two second isolated components 3 are arranged symmetrically about the center line of each antenna array unit 11, wherein the center line of each antenna array unit 11 is a straight line of a center point of each antenna element 111 in the antenna array unit 11. Each second isolated component 3 comprises a second separation plate 31 and a plurality of second metal patches 32 arranged on the second separation plate 31 in a spaced manner.

The second metal patches 32 are arranged in an equally spaced manner on the second separation plate 31, and the second metal patches 32 and two antenna elements 111 are correspondingly arranged in a spaced manner, for example, each antenna array unit 11 comprises three antenna elements 111, and two second metal patches 32 are arranged correspondingly on one side of the second separation plate 31. The second metal patches 32 are arranged in a spaced manner on two sides of the second separation plate 31.

Preferably, the antenna further comprises third isolated components 4 arranged on two sides of the antenna in the first direction, wherein one third isolated component 4 and the adjacent first isolated component 2 are arranged symmetrically about the center line of the antenna array part 1, so that the isolation degree of the antenna is further improved. The center line of the antenna array part 1 is the straight line of the center point of each antenna array unit 11 in the antenna array part 1.

Preferably, the antenna further comprises fourth isolated components 5 arranged on two sides of the antenna array part 1 in the second direction. The two fourth isolated components 5, one third isolated component 4 and the first isolated component 2 adjacent to the third isolated component 4 form an isolation structure encircling around the antenna array part 1. In another embodiment, the antenna comprises fifth isolated components (not shown in the drawings) arranged on two sides of the antenna in the second direction, that is, two fifth isolated components and two third separators 3 form an isolation structure encircling around the antenna, so that the isolation degree between the antenna and other antennas is improved.

In addition, the antenna further comprises a substrate 6. The antenna elements 111, the first isolated components 2 and the second isolated components 3 are arranged on the substrate 6, and the substrate 6 may be made from a PCB material or a plastic electroplated material, so that the stability of the antenna structure is ensured.

The invention further provides a base station which comprises the antenna.

According to the antenna and the base station provided by the invention, by arranging the first isolated component 2 between adjacent two antenna array parts 1 arranged in the first direction, each antenna array part 1 comprises a plurality of antenna array units 11 arranged in the second direction, and the second isolated component 3 is arranged between adjacent two antenna array units 11, so that the isolation degree of the antenna is improved.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

1. An antenna, comprising:
a plurality of antenna array parts arranged in a first direction, each antenna array part comprising a plurality of antenna array units arranged in a second direction which is perpendicular to the first direction; wherein
each antenna array unit comprises a plurality of antenna elements arranged in the first direction;
a first isolated component is arranged between adjacent two antenna array parts, and/or a second isolated component is arranged between adjacent two antenna array units.

2. The antenna as described in claim 1, wherein each first isolated component comprises two first separators arranged spaced from each other.

3. The antenna as described in claim 2, wherein each first separator comprises a first separation plate and a plurality of first metal patches arranged on the first separation plate in a spaced manner.

4. The antenna as described in claim 1, wherein adjacent two second isolated components are arranged symmetrically about a center line of each antenna array unit.

5. The antenna as described in claim 1, wherein each second isolated component comprises a second separation plate and a plurality of second metal patches arranged on the second separation plate in a spaced manner.

6. The antenna as described in claim 1, further comprising third isolated components arranged on two sides of the antenna in the first direction.

7. The antenna as described in claim 1, further comprising fourth isolated components arranged on two sides of each antenna array units in the second direction.

8. The antenna as described in claim 2, further comprising fourth isolated components arranged on two sides of each antenna array units in the second direction.

9. The antenna as described in claim 3, further comprising fourth isolated components arranged on two sides of each antenna array units in the second direction.

10. The antenna as described in claim 4, further comprising fourth isolated components arranged on two sides of each antenna array units in the second direction.

11. The antenna as described in claim 5, further comprising fourth isolated components arranged on two sides of each antenna array units in the second direction.

12. The antenna as described in claim 6, further comprising fourth isolated components arranged on two sides of each antenna array units in the second direction.

13. The antenna as described in claim 1, further comprising a substrate, wherein the antenna elements, the first isolated components and the second isolated components are arranged on the substrate.

13. (canceled)

13. (canceled)

13. (canceled)

13. (canceled)

13. (canceled)

14. The antenna as described in claim 1, wherein the antenna is a dual polarized antenna.

15. The antenna as described in claim 2, wherein the antenna is a dual polarized antenna.

16. The antenna as described in claim 3, wherein the antenna is a dual polarized antenna.

17. The antenna as described in claim 4, wherein the antenna is a dual polarized antenna.

18. The antenna as described in claim 5, wherein the antenna is a dual polarized antenna.

19. The antenna as described in claim 6, wherein the antenna is a dual polarized antenna.

20. A base station, comprising the antenna as described in claim 1.
